(19) United States
(12) Patent Application Publication
(10) Pub. No.: US 2014/0293600 A1
(43) Pub. Date: Oct. 2, 2014

(54) STRUCTURE OF INDOOR ILLUMINATING DEVICE

(71) Applicant: SHUNCHI TECHNOLOGY CO., LTD., TAICHUNG CITY (TW)

(72) Inventor: YOU-NAN HUNG, TAICHUNG CITY (TW)

(73) Assignee: SHUNCHI TECHNOLOGY CO., LTD., TAICHUNG CITY (TW)

(21) Appl. No.: 13/855,080

(22) Filed: Apr. 2, 2013

(51) Int. Cl. F21V 19/04

(52) U.S. Cl. CPC F21V 19/042
USPC 362/235

(57) ABSTRACT

A structure of indoor illuminating device has a substrate in a lamp housing. The light-emitting element of the light source module is disposed under the substrate. The heat sink of the light source module is located between the substrate and the lamp housing. A transparent mask covers the opening of the lamp housing under the substrate. A reflecting mask is disposed between the substrate and the transparent mask.

### BACKGROUND OF THE INVENTION

1. Field of Invention

The invention relates to an illuminating device and, in particular, to an indoor illuminating device.

2. Related Art

Please refer to the ROC Pat. No. M409352, which discloses a “high-power split LED illuminating structure.” It comprises an LED light source panel, an electrically conductive cover, a heat dissipating electrically conductive base, a control circuit board, and a heat sink main seat. The LED light source panel has a number of LED elements. The LED elements emit light after the power is on, achieving the illuminating effect.

The LED light source panel of that patent is designed to be replaceable. If the entire LED light board is damaged, is can be conveniently replaced. However, suppose only some of the LED elements are broken while the other LED elements are still working. When the number of broken LED elements is such that normal illumination is affected, one cannot merely replace the damaged LED elements but have to replace the entire LED light source board. This is a waste for those LED elements that can still work.

It is an objective of the invention to solve the above-mentioned problems.

### SUMMARY OF THE INVENTION

An objective of the invention is to solve the above-mentioned problems by providing a structure of an indoor illuminating device. The invention enables easy replacement of individual light source modules comprised of light-emitting elements and heat sinks, thereby achieving the goal of saving costs.

To achieve the above-mentioned objective, the invention includes: a lamp housing whose bottom has an opening surrounded by a plurality of cooling holes for ventilation:

a substrate accommodated in the lamp housing and having at least one through hole;

a plurality of light source modules, each of which includes a light-emitting element under the substrate and a heat sink between the substrate and the lamp housing, wherein one of the light-emitting element and the heat sink goes through the through hole of the substrate, connects to the other, and gets fixed on the substrate;

a transparent mask covering the opening under the substrate; and

a reflecting mask inside the lamp housing and interposed between the substrate and the transparent mask; wherein the light-emitting elements of the light source modules extend from the top of the reflecting mask into the reflecting mask.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional perspective view of the invention;

FIG. 2 is a three-dimensional exploded view of the invention;

FIG. 3 is a cross-sectional view of the invention;

FIG. 4 is a local cross-sectional view of the disclosed substrate fixed to the housing via the ear part thereof and the combining element; and

FIG. 5 is a local cross-sectional view of the disclosed light source module mounted on the through hole of the substrate.

### DETAILED DESCRIPTION OF THE INVENTION

The present invention will be apparent from the following detailed description, which proceeds with reference to the accompanying drawings, wherein the same references relate to the same elements.

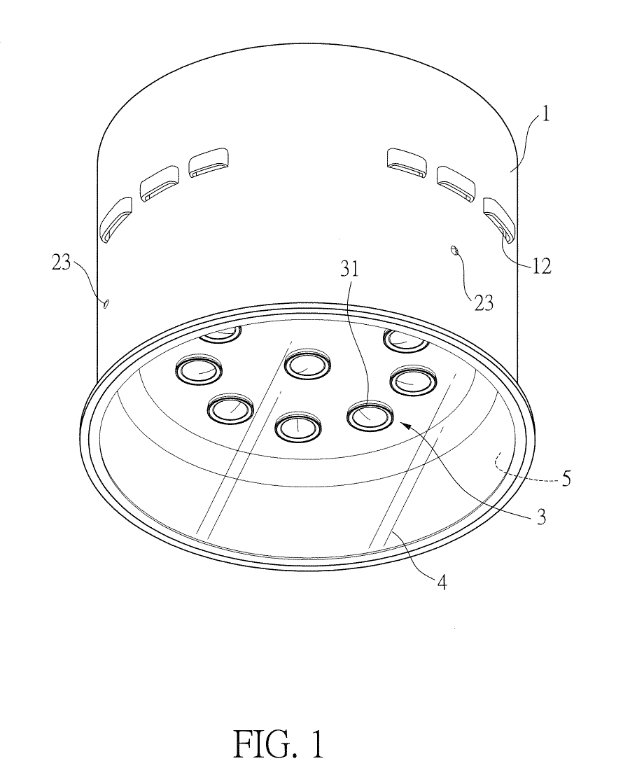

The present invention will be apparent from the following detailed description, which proceeds with reference to the accompanying drawings, FIGS. 1 to 5, wherein the same references relate to the same elements.

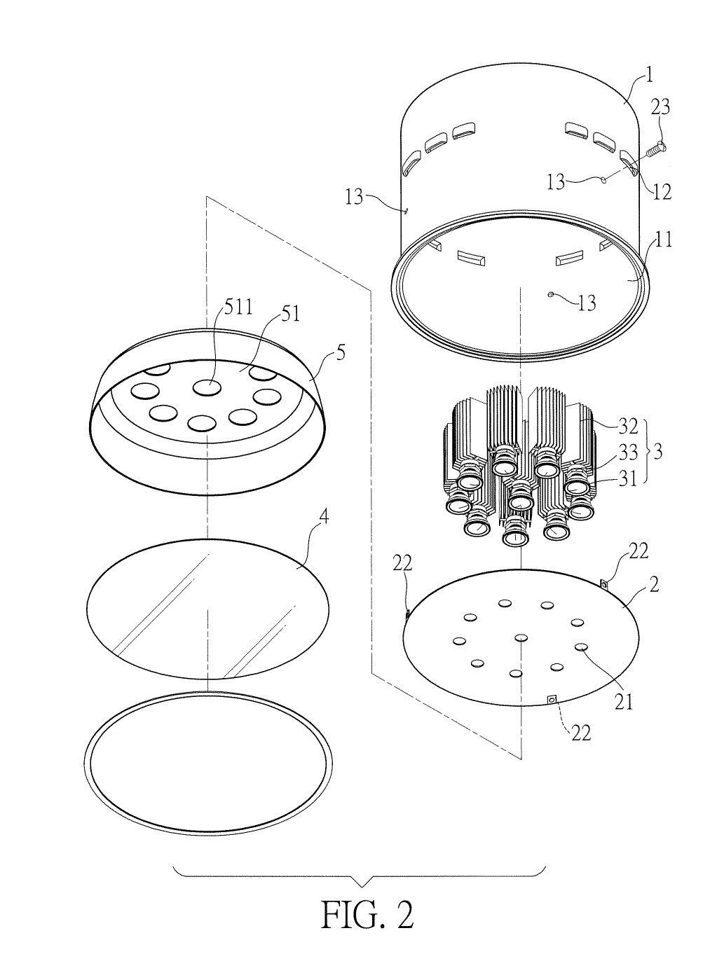

An embodiment of the invention provides the structure of an indoor illuminating device. As shown in FIGS. 1 and 2, it includes a lamp housing 1, a substrate 2, a plurality of light source modules 3, a light mask 4 and a reflecting mask 5.

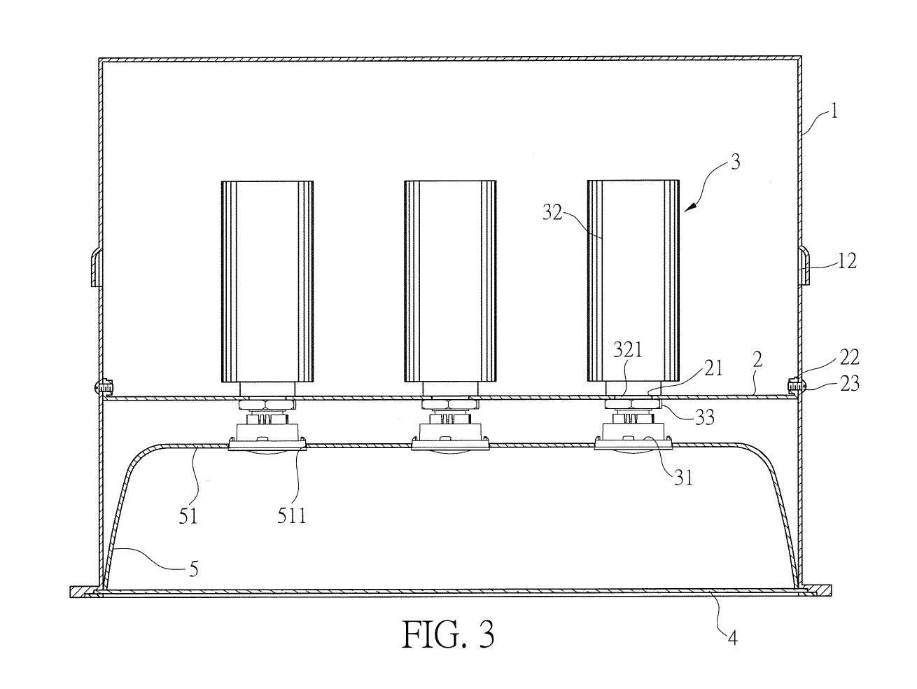

As shown in FIGS. 2 and 3, the lamp housing 1 is a round housing. Its bottom has an opening 11 surrounded by a plurality of cooling holes 12. The interior of the lamp housing 1 ventilates via the cooling holes 12 to the exterior.

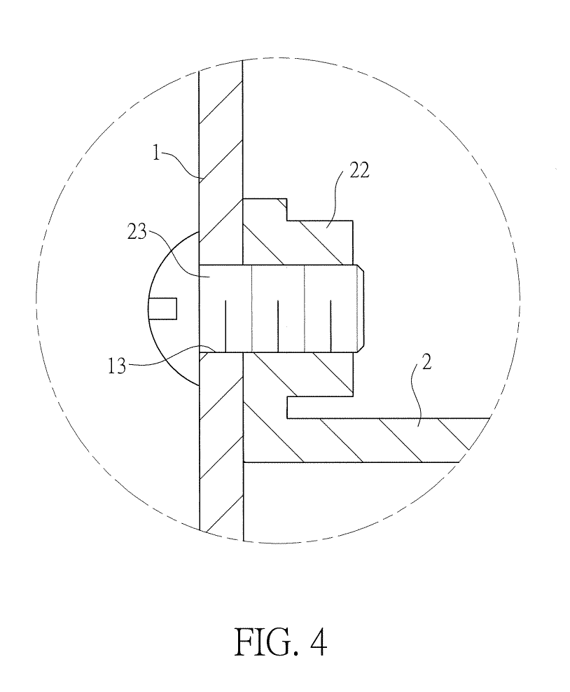

As shown in FIGS. 2 and 3, the substrate 2 in this embodiment is also spherical in accord with the lamp housing 1. The substrate 2 is disposed inside the lamp housing 1, and has a number of through holes 21. Each through hole 12 offers the mounting of a light source module 3. In this embodiment, the substrate 2 is horizontally disposed in the lamp housing 1. Both sides of the substrate 2 are provided with a plurality of ear parts 22. Each of the ear parts 22 is upright with respect to the substrate 2. Each of the ear parts 22 is fixed to the map housing 1 using a combining element. Please refer to FIG. 4. The combining element is a screw 23 in this embodiment. The lamp housing 1 has a through hole 13 at the location of each of the ear parts 22. The screw 23 goes through the corresponding through hole 13 and locks into the ear part 22 at the location, thereby fixing the substrate 2 in the lamp housing 1.

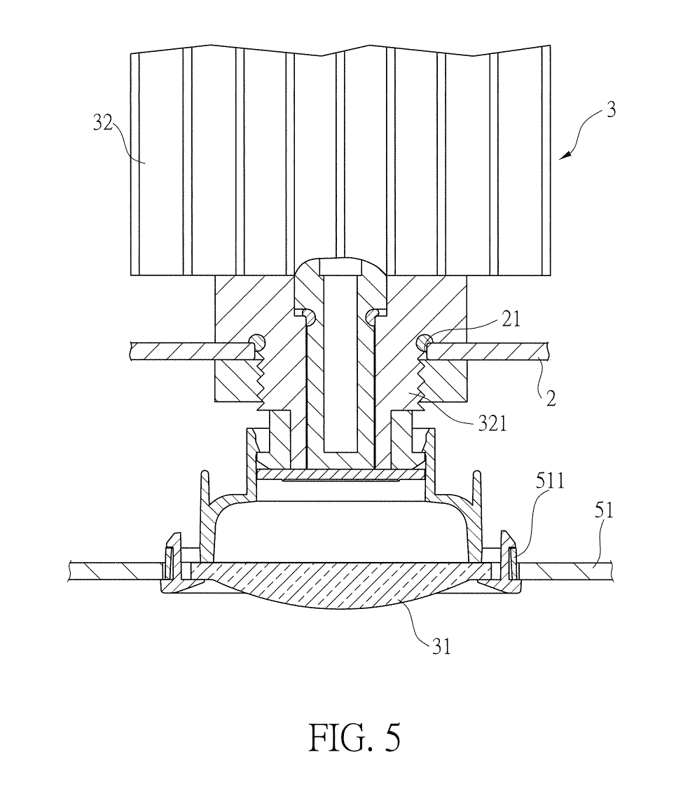

As FIGS. 2 and 3 show, each of the light source modules includes a light-emitting element 31 and a heat sink 32. The light-emitting element 31 is disposed under the substrate 2, and the heat sink 32 is disposed on the substrate 2. Moreover, the heat sink 32 is interposed between the substrate 2 and the lamp housing 1. One of the light-emitting element 31 and the heat sink 32 goes through a through hole on the substrate 2 to connect to the other and to be fixed on the substrate 2. As shown in FIG. 5, heat sink 32 of each of the light source modules 3 in this embodiment has a connecting part 321 extending through the through hole 21. The connecting part 321 in this embodiment is an outer thread part, fixing the heat sink 32 on the substrate 2 using a fixing element that connects under the substrate 2 to the connecting part 321. The fixing element in this embodiment is a nut 33 corresponding to the connecting part 321. When the light-emitting element 31 emits light, the irradiated heat is absorbed by the heat sink 32 and transferred to the lamp housing 1 for heat exchange with the air. The hot air within the lamp housing 1 after the heat exchange goes out of the cooling holes 12, achieving the cooling effect.

As shown in FIGS. 2 and 3, the transparent mask 4 covers the opening 11 under the substrate 1. As shown in the drawings, the reflecting mask 5 is disposed in the lamp housing 1 and between the substrate 2 and the transparent mask 4. The light-emitting elements 31 of the light source modules 3 extend from the top of the reflecting mask 5 into the reflecting mask 5. The reflector 5 in this embodiment has a layer 51 at the top and under and parallel to the substrate 2. The layer 51 has a number of through holes 511, each of which offers the corresponding light source module 3 to go through inside the reflecting mask 5. When the light-emitting elements 31 of the light source modules 3 emit light, the light is guided by the reflecting mask 5 toward the opening 11.

Suppose some light source modules 3 on the substrate 2 are damaged. Since the substrate 2 is fixed to the lamp housing 1 via combining elements, one can take the substrate 2 out of the lamp housing 1 by releasing all of the combining elements. One can then replace the damaged light source modules individually. This is done by taking the light-emitting element off the connecting part 321, and then taking the fixing element off the connecting part 321. At this point, the heat sink 32 can be removed from the substrate 2. The new light source modules 3 are then installed in the reverse order onto the substrate 2. This completes the replacement of the light source modules 3.

The above description shows the following advantages of the invention. When one light source module 3 installed on the substrate 2 is broken, one can easily replace the light source module with a new one. In comparison with the prior art, the invention does not have problem that one needs to replace the entire LED light source board when only some of the LED elements are broken. Therefore, the invention is cost-saving.

It is worth mentioning that if the lamp housing 1 is changed to have a different type of geometry, such as square or ellipse, the substrate 2 also changes with the lamp housing 1. The screw 23 still goes through the ear part 22 to fix the substrate 2 and the lamp housing 1. This is very convenient for assembly when the substrate 2 and the lamp housing 1 change their shapes.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A structure of an indoor illuminating device, comprising:
a lamp housing whose bottom has an opening surrounded by a plurality of cooling holes;
a substrate disposed in the lamp housing and having at least one through hole;
a plurality of light source modules, each of which includes a light-emitting element under the substrate and a heat sink interposed between the substrate and the lamp housing, wherein one of the light-emitting element and the heat sink goes through the through hole of the substrate, connects to the other, and gets fixed on the substrate;
a transparent mask covering the opening under the substrate; and
a reflecting mask inside the lamp housing and interposed between the substrate and the transparent mask; wherein the light-emitting elements of the light source modules extend from the top of the reflecting mask into the reflecting mask.

2. The structure of an indoor illuminating device according to claim 1, wherein the substrate is horizontally disposed in the lamp housing and surrounded by a plurality of ear parts upright with respect to the substrate, and each of the ear parts is fixed to the substrate and the lamp housing by a combining element.

3. The structure of an indoor illuminating device according to claim 2, wherein the combining element is a screw.

4. The structure of an indoor illuminating device according to claim 1, wherein the heat sink of each of the light source modules has a connecting part going through the through hole, and a fixing element connects to the connecting part under the substrate, thereby fixing the heat sink onto the substrate.

5. The structure of an indoor illuminating device according to claim 4, wherein the connecting part is an outer thread part, and the fixing element is a nut for the connecting part to engage.

6. The structure of an indoor illuminating device according to claim 1, wherein the reflecting mask has a layer at the top thereof, the layer is under and parallel to the substrate, and the layer has a plurality of through holes for the light-emitting elements of the light source module to go through and into the reflecting mask.
